(19) United States
(12) Patent Application Publication
(10) Pub. No.: US 2005/0019641 A1
(43) Pub. Date: Jan. 27, 2005

(54) Fuel tank for fuel-cell and fuel cell system

(76) Inventors: Toshiyuki Aoyama, Settsu-shi (JP); Kenji Hasegawa, Hirakata-shi (JP); Masaru Higashionji, Katano-shi (JP); Masafumi Shimotashiro, Katano-shi (JP); Masayuki Ono, Osaka-shi (JP); Kenya Hori, Tsuyama-shi (JP); Masaru Odagiri, Kawanishi-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/868,833

(22) Filed: Jun. 17, 2004

(30) Foreign Application Priority Data
Jun. 18, 2003 (JP) 2003-173239

(51) Int. Cl. H01M 8/04; B65D 88/00

(52) U.S. Cl. 429/34; 220/567.2

(57) ABSTRACT

Present invention provides a fuel tank for a fuel-cell, as well as a fuel cell system, which allow stable fuel supply to be performed whichever orientation they are set up along, and further which perform the disposal of emission as well. The fuel tank and fuel cell system have a partition plate which moves inside a casing and pressurizes fuel supplied to the fuel cell main unit by the emission discharged from the fuel cell main unit. Thus, the fuel can be supplied to the fuel cell main unit stably, whichever orientation the fuel tank and the fuel cell system are set up along. Further, since the emission is used to press the partition plate, the disposal of the emission can also be performed.

### TECHNICAL FIELD

The present invention relates to a fuel tank for a fuel-cell which is to be connected to a fuel cell main unit that generates electric power while an organic fuel such as methanol being supplied directly to an anode, as well as to a fuel cell system equipped with the fuel tank.

### BACKGROUND OF THE INVENTION

In recent years, fuel cell systems have been drawing attention as a next-generation clean, high-efficiency energy source. Among others, PEFCs (Polymer Electrolyte Fuel Cells) in which an anode and a cathode are so placed as to sandwich a solid polymer electrolyte have been drawing attention as utilities of electric-car power supply and household distributed power supply. Among the PEFCs, for example, DMFCs (Direct Methanol Fuel Cells), which are fuel cells in which an organic fuel such as methanol or dimethyl ether is supplied directly to the anode to generate electric power, do not need any reformer for reforming the organic fuel such as methanol into a gas containing an abundance of hydrogen, hence convenient to construct and having been in the spotlight as utilities of portable equipment and thus under ongoing development.

In order to apply the fuel cell to utilities such as the portable equipment, there is a requirement that the direction in which the fuel cell system is placed should have flexibility. That is, it is required that the fuel should be supplied stably to a fuel cell main unit in any direction of the placement of the portable equipment. For example, as a method for stably supplying fuel, there has been proposed one comprising an adjustment mechanism which allows fuel supply pressure to be maintained constant at a liquid fuel lead-out portion (see, e.g., Patent Document 1: Japanese unexamined patent application No. 2001-93551).

On the other hand, the DMFC generates electric power by the following reactions:
Anode: CH₃OH+H₂O →6H+6e⁻+CO₂
Cathode: 6H+6e⁻+3/20₂→3H₂O

As apparent from the above reactions, an amount of water three times larger than that consumed at the anode is produced at the cathode. This gives rise to a need for treating the water produced at the cathode. If this water is discharged, for example, outward of the portable equipment, as water or steam is emitted outward, a problem that water droplets would be deposited onto the portable equipment is caused. Besides, in the case where the portable equipment is housed, for example, in a bag or pocket with the fuel cell in operation, there arises a problem that the bag or pocket inside would be wetted, or the like.

In order to solve such problems, there has been proposed a fuel cell in which a bag-like partition wall is formed within a fuel cartridge so that emissions are stored therein (see, e.g., Patent Document 2: Japanese unexamined patent application No. 2003-92128).

Further, there has been proposed a fuel cell in which the fuel can be supplied from a fuel tank to a fuel cell main unit without using any special motive power (see, e.g., Patent Document 3: Japanese unexamined patent application No. H04-223058).

### SUMMARY OF THE INVENTION

However, in the method disclosed in the Patent Document 1, the fuel supply from the liquid fuel lead-out portion to the fuel cell main unit is effected by capillary force. Therefore, the fuel supply force is weak in the method of Patent Document 1, making it hard to apply the method of Patent Document 1 to fuel-circulating type fuel cell systems in which the fuel is circulated within the fuel cell.

Also, in the proposal disclosed in the Patent Document 2, a structure of the fuel cartridge inevitably becomes complex, causing the manufacturing cost of the fuel cartridge to increase. There are further problems such as a possibility that the bag-like partition wall may be damaged or a possibility that a hollow needle in use may be damaged. Furthermore, whereas not only water but also unreacted air or oxygen or other gas is also discharged from the cathode, there is no description on treatment of the gas in the Patent Document 2.

Further, in the proposal disclosed in the Patent Document 3, since the liquid fuel is pressurized by shrinkage force of an elastic diaphragm, the pressurizing force of the liquid fuel varies depending on the shrinkage force. That is, as in a graph shown by a dotted line of FIG. 19, the fuel pressurizing force is high and the discharge pressure is high upon a start of power generation, i.e., with the liquid fuel in a full state, whereas the fuel pressurizing force becomes lower and the discharge pressure becomes lower with the fuel in an almost empty state after an elapse of the operating time. Thus, there are a problem that the liquid fuel supply pressure is inconstant against the elapse of the operating time of the fuel cell, and a possibility that the elastic diaphragm may be damaged.

The present invention has been accomplished to solve these and other problems, an object of the invention is to provide a fuel tank for a fuel-cell and a fuel cell system in each of which stable fuel supply can be performed in any direction of their placement, and in each of which emission treatment is further performed.

In accomplishing these and other objects, according to a first aspect of the present invention, there is provided a fuel tank for a fuel-cell which is connectable to a fuel cell main unit having an anode and a cathode, the fuel tank comprising:

a casing; and

a partition plate which is configured to move within the casing, is configured to partition interior of the casing into a fuel storage portion that stores a liquid fuel to be supplied to the anode and a fuel pressurizing portion that is capable of storing emission derived from the cathode, and further is configured to move by a pressure increase in the fuel pressurizing portion with the emission supplied to the fuel pressurizing portion so as to pressurize the liquid fuel in the fuel storage portion, without moving the partition plate when the emission is not supplied to the fuel pressurizing portion so as not to pressurize the liquid fuel.

Also, the emission may be at least one of a gas and a liquid supplied from the cathode.

Also, the fuel tank may further comprise a pressure-increase preventing portion configured to prevent pressure increase beyond a set pressure value in the fuel pressurizing portion.

Also, the pressure-increase preventing portion may be a pressure bleeding valve provided at part of the casing forming the fuel pressurizing portion.

Also, the fuel tank may further comprise a water absorptive member in the fuel pressurizing portion.

Also, the water absorptive member may be a water absorptive polymer.

Also, the water absorptive polymer may be composed principally of at least one of cellulose, polyvinyl alcohol and acrylate.

Also, the fuel tank may further comprise a partition-plate moving guide portion configured to guide movement of the partition plate within the casing.

Also, the partition-plate moving guide portion may be a depressed-and-projected portion formed on a casing inner wall.

Also, the partition-plate moving guide portion may be a guide rod which is formed within the casing along an axial direction of the casing so as to penetrate the partition plate.

Also, at least part of the casing may be made of a transparent or translucent material, and the partition plate may at least partly have a colored part which allows remaining quantity of the liquid fuel within the fuel-cell use fuel tank to be visually recognized.

Also, the fuel tank may further comprise an attachable-and-removable mechanism which allows the fuel cell main unit and the fuel-cell use fuel tank to be removably connected to each other.

Also, the attachable-and-removable mechanism may have a check valve configured to prevent back flow of the emission from the fuel pressurizing portion to the cathode.

Further, according to a second aspect of the present invention, there is provided a fuel cell system which is equipped with the fuel tank as defined in any one of the foregoing first aspects.

Further, according to a third aspect of the present invention, there is provided a fuel cell system comprising:

a fuel cell main unit which has an anode and a cathode with an electrolyte membrane sandwiched therebetween and which supplies a liquid fuel to the anode and supplies an oxidizer made of gas to the cathode so as to perform power generation; and

a fuel tank having a partition plate which is configured to move within a casing of the fuel tank, is configured to partition interior of the casing into a fuel storage portion that stores a liquid fuel to be supplied to the anode and a fuel pressurizing portion that is capable of storing emission derived from the cathode, and further is configured to move by a pressure increase in the fuel pressurizing portion with the emission supplied to the fuel pressurizing portion so as to pressurize the liquid fuel in the fuel storage portion, without moving the partition plate when the emission is not supplied to the fuel pressurizing portion so as not to pressurize the liquid fuel.

Also, in the third aspect, the fuel may be a solution containing methanol and the gas may be air.

As described above, according to the fuel tank of the first aspect and the fuel cell system of the second aspect of the present invention, the casing is partitioned into the fuel storage portion and the fuel pressurizing portion by the partition plate provided within the casing, and when the emission discharged from the fuel cell main unit is supplied to the fuel pressurizing portion, the partition plate that is moved within the casing is pressed by a pressure increase in the fuel pressurizing portion, thereby pressurizing the fuel supplied to the fuel cell main unit by the partition plate. As described above, the partition plate does not pressurize the liquid fuel with the emission unsupplied to the fuel pressurizing portion, but pressurize the liquid fuel with the emission supplied, thus making it possible to accomplish a stable fuel supply. Therefore, whichever orientation the fuel tank is disposed along, the fuel can be supplied to the fuel cell main unit stably. Also, since the emission is stored in the fuel pressurizing portion, the disposal of the emission can be performed as well.

Also, since the partition plate is pressed by the emission, there is no need for providing a pressurizing mechanism such as a spring in the fuel tank, thus allowing the fuel tank to be simplified in construction.

Also, since air or oxygen or other gas as an oxidizer is supplied to the cathode, unreacted gas and produced liquid are discharged from the cathode. Thus, by making use of these gas or liquid for the aforementioned pressing, the fuel tank can be further simplified in construction.

Also, the provision of the pressure-increase preventing portion provided in the fuel pressurizing portion makes it possible to control the pressure in the fuel pressurizing portion, by which the internal pressure of the fuel pressurizing portion can be prevented from increasing more than necessary. Thus, the fuel can be prevented from being supplied more than necessary to the fuel cell main unit, making it possible to accomplish a stable supply of the liquid fuel and moreover to prevent damage or the like of the fuel tank.

With the pressure bleeding valve provided as the pressure-increase preventing portion, the pressure-increase preventing portion can be constructed simply.

Also, the provision of the water absorptive member in the fuel pressurizing portion makes it possible to solidify water as the emission. As a result of this, water can be prevented from flowing out from the fuel pressurizing portion. Further, composing the water absorptive polymer principally of water absorptive polymer or the like makes it possible to satisfy both water absorptivity and cost at the same time.

Also, the provision of the partition-plate moving guide portion makes the movement direction of the partition plate constant, so that the fuel pressurization can be achieved without any tilt of the partition plate. Further, providing the partition-plate moving guide portion in a rod or depressed-and-projected shape makes it possible to simplify the structure of the partition-plate moving guide portion, so that the structure in the casing can be prevented from becoming complex.

Also, making at least part of the casing transparent or translucent makes it possible to visually see the inside of the fuel tank, so that the remaining quantity of the fuel can be visually recognized. Further, coloring at least part of the partition plate makes it possible to improve the visibility in the checking of the fuel remaining quantity.

Also, removably connecting the fuel tank and the fuel cell main unit to each other makes it possible to improve the operability in the fuel supply to the fuel tank. Further, providing the check valve makes it possible to prevent back flow of the emission from the fuel pressurizing portion to the fuel cell main unit, in particular, to prevent the back flow upon a halt of operation of the fuel cell main unit.

Furthermore, according to the fuel cell system of the third aspect of the present invention, the fuel tank is provided so that the fuel supplied to the fuel cell main unit is pressurized by the fuel pressurizing portion. Thus, whichever orientation the fuel cell system is disposed along, the fuel can be supplied stably to the fuel cell main unit, making it possible to perform a stable power generation.

Also, when the fuel is a solution containing methanol and the gas supplied to the cathode of the fuel cell main unit is air, it becomes possible to generate the electric power at low cost.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a sectional view of an example of a fuel tank for fuel-cell which is an embodiment of the present invention;

FIG. 2 is a view showing a state in which the partition plate has been moved in the fuel tank shown in FIG. 1;

FIG. 3 is a view showing a case where a partition-plate reverse-move preventing portion is provided on a tank inner wall in the fuel tank shown in FIG. 1;

FIG. 4 is a view showing an example of a structure of a pressure bleeding valve provided in the fuel tank shown in FIG. 1;

FIG. 5 is a view showing another example of a structure of the pressure bleeding valve shown in FIG. 4;

FIG. 6 is a view showing a structure of a modification of the fuel tank shown in FIG. 1;

FIG. 7 is a view showing a state that a water absorptive member shown in FIG. 6 has absorbed water and swollen;

FIG. 8 is a plan view of a partition wall showing an example of the partition wall shown in FIG. 6;

FIG. 9 is a plan view of a partition wall showing another example of the partition wall shown in FIG. 6;

FIG. 10 is a plan view of a partition wall showing yet another example of the partition wall shown in FIG. 6;

FIG. 11 is a view showing a structure of another modification of the fuel tank shown in FIG. 1;

FIG. 12 is a view showing a modification of a partition-plate moving guide portion shown in FIG. 11;

FIG. 13 is a view showing a structure of yet another modification of the fuel tank shown in FIG. 1;

FIG. 14 is a view showing a structure of another modification of the fuel tank shown in FIG. 1;

FIG. 15 is a view showing an example of a structure of a check valve shown in FIG. 14;

FIG. 16 is a view showing another example of a structure of the check valve shown in FIG. 14;

FIG. 17 is a view showing a structural example of a fuel cell system which is another embodiment of the present invention;

FIG. 18 is a perspective view showing a state that the fuel cell system shown in FIG. 17 is loaded into a personal computer;

FIG. 19 is a graph showing a variation in fuel supply pressure in the fuel tanks shown in FIGS. 1, 6, 11, 13 and 14;

FIG. 20 is a perspective view showing an example of an interface between a fuel cell main unit part, and a fuel discharge port and a receiving port for emission of the fuel tank, in the fuel cell system shown in FIG. 17;

FIG. 21 is a perspective view showing another example of the interface between the fuel cell main unit part, and the fuel discharge port and the receiving port for emission of the fuel tank;

FIG. 22 is a sectional view showing a structure of the fuel tank in the cases of the interfaces shown in FIGS. 20 and 21; and

FIG. 23 is a perspective view for explaining placement directions of the pressure bleeding valves of the fuel tanks shown in FIGS. 1, 6, 11, 13 and 14.

### DETAILED DESCRIPTION OF THE PREFERRED EMBODIMENTS

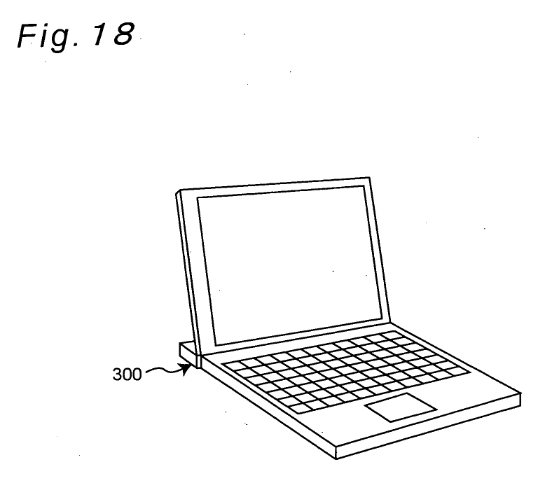

A fuel tank for a fuel-cell and a fuel cell system equipped with the fuel tank, which are embodiments of the present invention, are described below in detail with reference to the accompanying drawings. It is noted that like constituent members are designated by like reference numerals throughout the drawings. The fuel cell system is suitably attached, for example, to mobile equipments such as portable telephones, and small-size, portable-use equipments such as personal computers as shown in FIG. 18.

First, the fuel tank for the fuel-cell is explained on each embodiment.

First Embodiment:

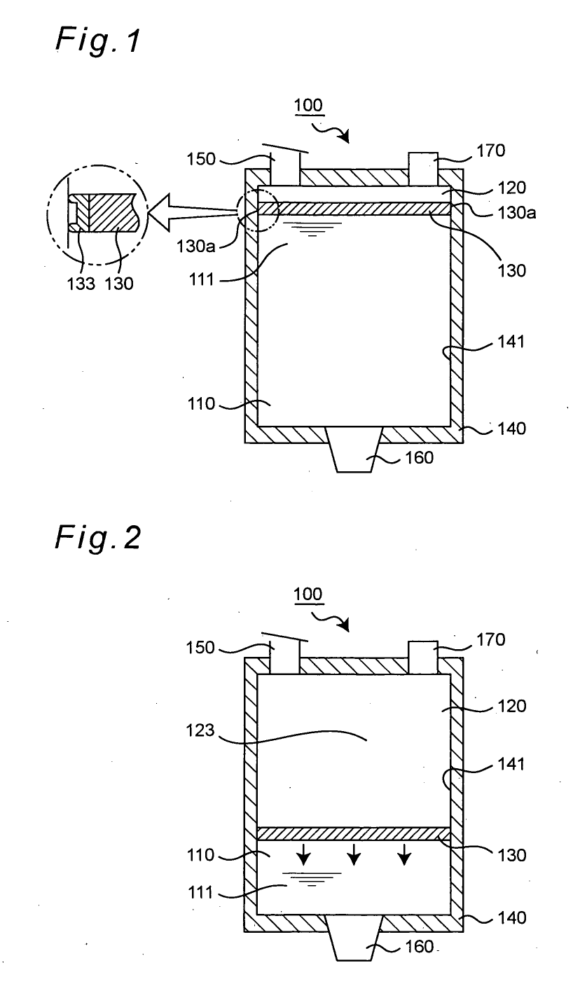

FIGS. 1 and 2 show the fuel tank 100 of a first embodiment. The fuel tank 100 has a partition plate 130 and a casing 140 as basic components. This fuel tank 100 further includes a pressure bleeding valve 150, a fuel discharge port 160 and a receiving port for emission 170, and is connected to a later-described fuel cell main unit. Also, the connection between the fuel tank 100 and the fuel cell main unit may be made with a structure that the two units are attachable and removable. In the case of the attachable-and-removable structure, the fuel discharge port 160 and the receiving port for emission 170 may be given by an attachable-and-removable mechanism against the fuel cell main unit.

Such the fuel tank 100 has the hollow casing 140 formed into a cylindrical, rectangular-cylindrical or other like shape. Within the casing 140 is placed the partition plate 130 that moves along an axial direction of the casing 140 while kept in contact with an inner wall 141 of the casing 140 and that partitions an interior of the casing 140 into two chambers, i.e., a fuel storage portion 110 and a fuel pressurizing portion 120. As will be described later, the partition plate 130 acts to pressurize fuel which is stored in the fuel storage portion 110. It is noted that an amount of fuel storage in the fuel tank 100 is about 50 to about 200 milliliters, and about 100 milliliters in the fuel tank 100 of this embodiment.

In the fuel storage portion 110 is filled a liquid fuel 111 or liquid fuel solution which is to be supplied to an anode of the fuel cell main unit. Preferably, the liquid fuel 111 is exemplified by organic solutions such as methanol, dimethyl ether and the like, and methanol is particularly preferable. The casing 140 defining the fuel storage portion 110 is provided with the fuel discharge port 160 for supplying the liquid fuel 111 to the anode of the fuel cell main unit.

When the fuel tank 100 is connected to the fuel cell main unit, the fuel pressurizing portion 120 serves as a chamber to which an emission 123 derived from a cathode of the fuel cell main unit is supplied, and the casing 140 in the fuel pressurizing portion 120 is provided with the receiving port for emission 170, which is an inlet for the emission 123. The emission 123 is at least one of a liquid produced at the cathode and a gas that has passed through the cathode. In this embodiment, the emission 123 is the liquid or the gas or a mixture of these, and principally the mixture. Therefore, a pressure generated at the fuel pressurizing portion 120 is generally proportional to a discharge pressure of an air supply pump 271 that supplies air to the cathode 230 of the fuel cell main unit 200 which will be described later. In this embodiment, in which a motor type air supply pump 271 is used as an example, a discharge air flow rate is preferably about 1 to 4 liters per minute as an example, and the air supply pump 271 is set to an air flow rate of about 2 liters per minute. Therefore, the pressure generated at the fuel pressurizing portion 120 becomes a pressure based on the aforementioned air flow rate of about 2 liters per minute in this embodiment.

At a time in initial use of the fuel tank 100, the fuel pressurizing portion 120 preferably has a lower occupancy in the casing 140 as shown in FIG. 1, more specifically, not more than 20%. With the occupancy beyond 20%, an initial fuel occupancy inside the casing 140 would decrease largely, causing a fill quantity of the fuel to decrease. The fuel pressurizing portion 120 is, in its initial use, an empty space in which no substance is present. As a modification, a water absorptive member or the like may also be stored in the fuel pressurizing portion 120 as will be described later.

The partition plate 130, as described above, is a plate member for dividing the interior of the casing 140 into the fuel storage portion 110 and the fuel pressurizing portion 120, and is so made up that an O-ring or the like formed of, for example, an elastic member, and a seal member 133 of such a configuration as shown in the figure, are provided at an outer peripheral portion 130a of the partition plate 130 that is in contact with the inner wall 141 of the casing 140, thereby preventing the fuel 111 of the fuel storage portion 110 and the emission 123 of the fuel pressurizing portion 120 from being mixed together. Such the partition plate 130 is made of a material having a low permeability of water and the liquid fuel 111, and usable materials therefor are exemplified by polymeric resins such as polyethylene terephthalate, polycarbonate and Teflon®, and glasses, and metals such as aluminum and stainless steel. A plate thickness of the partition plate 130 is preferably a thinner one with a view to improving the initial fuel occupancy in the casing 140, but too thin a thickness would lead to an insufficient strength in pressurization. Thus, a preferable thickness varies depending on material used at the partition plate 130 and size thereof. The partition plate 130 in this embodiment has a thickness of about 1 mm.

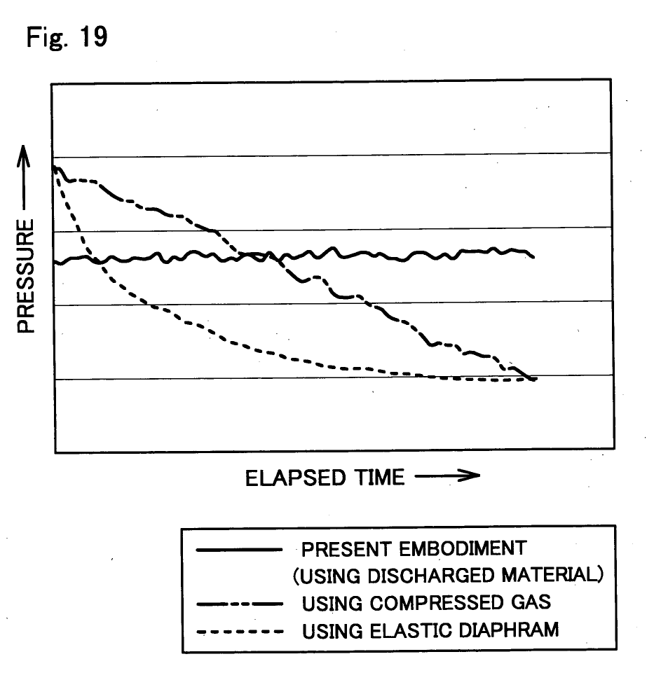

The partition plate 130 is a member that does not pressurize the liquid fuel 111 with the emission 123 unsupplied to the fuel pressurizing portion 120 and that is moved inside the casing 140 along its axial direction by pressure increase of the fuel pressurizing portion 120 resulting from the supply of the emission 123 thereby pressurizing the liquid fuel 111 of the fuel storage portion 110. Since the air supply pump 271 supplies air to the cathode 230 at a generally constant flow rate in this embodiment as described above, the fuel pressurizing portion 120 is maintained at a generally constant pressure from the beginning of the supply of the emission 123. Thus, the partition plate 130 is enabled to pressurize the fuel 111 of the fuel storage portion 110 at the generally constant pressure at all times as shown in FIG. 19. Furthermore, a partition plate 130 made of a rigid material is preferable because the pressurizing force of the fuel 111 becomes stable so that the fuel 111 can be pressurized at a generally constant pressure independent of time elapse as shown in FIG. 19. However, the partition plate 130 does not necessarily need to be made of the rigid material as far as the partition plate 130 performs action that the partition plate 130 does not pressurize the fuel 111 with the emission 123 unsupplied to the fuel pressurizing portion 120, i.e., in a state before the start of power generation, and pressurize the fuel 111 with the emission 123 supplied, i.e., after the start of power generation, as described above.

Further, the fuel 111 is a substance that adversely affects the human body when the fuel 111 has leaked outside from the fuel tank 100. Since the partition plate 130 does not pressurize the fuel 111 with the emission 123 unsupplied to the fuel pressurizing portion 120 as described above, the partition plate 130 acts so as to prevent the fuel 111 from leaking outside. In this respect, the fuel tank 100 in this embodiment is so constituted to have a high safety.

Since the fuel pressurizing portion 120 receives action of the pressure due to the emission 123 as described later, the material of the casing 140 is not particularly limited only if it has such a strength as not to be damaged by the pressure acting on the fuel pressurizing portion 120 and if it is a material free from leakage of water or the liquid fuel 111. Examples of usable materials therefor are polymeric resins such as polyethylene terephthalate, polycarbonate and Teflon®, and glasses, and metals such as aluminum and stainless steel. In particular, the polymeric resins are preferable in terms of their light weight and strength.

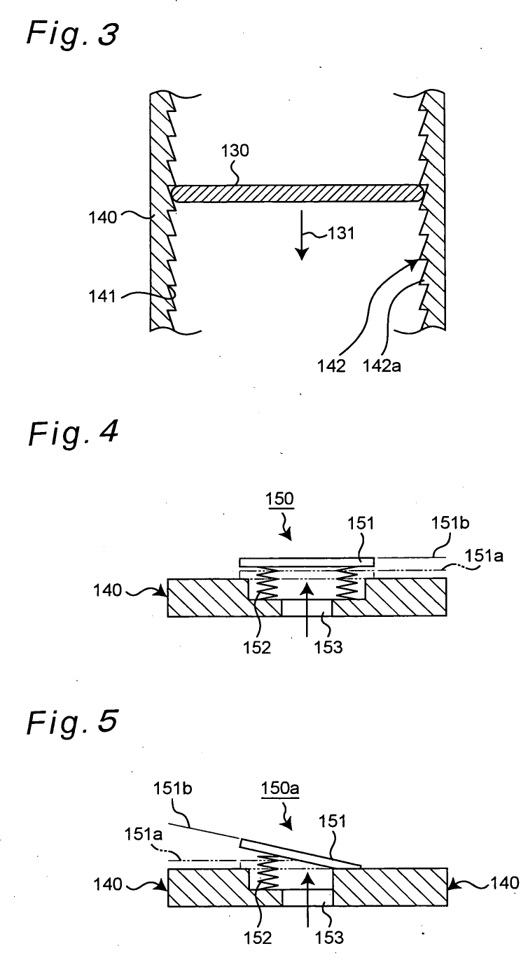

Further, it is also possible to form a reverse-move preventing portion 142 may also be formed at places of the inner wall 141 of the casing 140 that are in contact with the partition plate 130. As an example of the reverse-move preventing portion 142, an engagement member 142a having a right-angled triangle shaped cross section and sloped so as to ascend toward a move direction 131 of the partition plate 130 as shown in FIG. 3 may be formed on the inner wall 141. With the formation of the reverse-move preventing portion 142, the partition plate 130 after having moved to the fuel storage portion 110 side can be prevented from returning to the fuel pressurizing portion 120 side. In addition, even in the case where the reverse-move preventing portion 142 is formed, since the seal member such as an O-ring is provided on the outer peripheral portion 130a of the partition plate 130 as described above, the fuel 111 in the fuel storage portion 110 and the emission 123 in the fuel pressurizing portion 120 are never mixed together.

The pressure bleeding valve 150, which corresponds to one example of members having function of a pressure-increase preventing portion, serves to automatically control and reduce the internal pressure in the fuel pressurizing portion 120 with the pressure of the fuel pressurizing portion 120 beyond a set pressure, and is arranged at a trunk portion of the casing 140 forming the fuel pressurizing portion 120. A schematic construction in one example of the pressure bleeding valve 150 is shown in FIG. 4. The pressure bleeding valve 150 has a pressure relief member 151, a spring 152 and a gas-liquid separation membrane 153. For the pressure relief member 151, polymeric resins such as polyethylene and polypropylene and metals such as aluminum and stainless steel can be used. The gas-liquid separation membrane 153 is to prevent water or other moisture contents from leaking from the pressure bleeding valve 150 outside the tank 100. The material therefor is exemplified by fluorine-based FEP resin or the like, and its thickness is normally about 10 to 1000 micrometers.

In such the pressure bleeding valve 150, while the pressure of the fuel pressurizing portion 120 is below the set pressure, the pressure relief member 151 is located at a closure position 151a by shrinkage force of the spring 152, thus sealing the fuel pressurizing portion 120. On the other hand, when the pressure of the fuel pressurizing portion 120 has gone beyond the set pressure, the pressure relief member 151 overcomes the shrinkage force of the spring 152 so as to be located at an open position 151b, thus reducing the internal pressure of the fuel pressurizing portion 120.

This provision of the pressure bleeding valve 150 makes it possible to prevent the pressure in the fuel pressurizing portion 120 from going beyond the set pressure, so that the pressing force on the fuel 111 by the partition plate 130 never goes beyond the set value, and that the fuel 111 can be prevented from being pressurized over the set value. Thus, abnormal supply of the fuel 111 can be prevented.

As a modification of the pressure bleeding valve 150, as shown in FIG. 5, it is also possible to make up a pressure bleeding valve 150a in which the pressure relief member 151 has one end portion formed into a hinge and is so made as to be pivotable between the closure position 151a and the open position 151b. This pressure bleeding valve 150a is simplified in construction over the pressure bleeding valve 150. As the material of a pressure relief member 151 in the pressure bleeding valve 150a, polymeric resins such as polyethylene and polypropylene are preferable.

With regard to the fuel tank 100 of the first embodiment constructed as described above, operation of the fuel tank 100 is described below, in the case where the fuel storage portion 110 of the fuel tank 100 and the anode of the fuel cell main unit are connected to each other, and where the fuel pressurizing portion 120 of the fuel tank 100 and the cathode of the fuel cell main unit are connected to each other.

Upon the start of power generation in the fuel cell main unit, the emission 123 that is at least one of the gas that has passed through the cathode of the fuel cell main unit and the liquid produced at the cathode is supplied to the receiving port for emission 170. It is noted that the emission 123 is principally the mixture of liquid and gas in this embodiment as described before. Also, the start of power generation generally coincides with the start of air supply to the cathode 230 by the air supply pump 271. The fuel pressurizing portion 120 is increased in pressure by the supplied emission 123, so that the partition plate 130 is moved toward the fuel storage portion 110, i.e. along the move direction 131, to pressurize the fuel 111 stored in the fuel storage portion 110. By this pressurization, the fuel 111 is supplied to the anode of the fuel cell main unit through the fuel discharge port 160. In addition, when the internal pressure of the fuel pressurizing portion 120 has gone beyond the set pressure, the pressure bleeding valve 150 is automatically opened so that the gas is emitted outside from within the fuel pressurizing portion 120 through the gas-liquid separation membrane 153, thereby reducing the internal pressure of the fuel pressurizing portion 120. Thus, the fuel pressurizing portion 120 maintains a constant pressure that is below the set pressure and necessary for fuel supply, continuing to press the partition plate 130 toward the fuel storage portion 110. FIG. 2 is a schematic diagram of the fuel tank 100 that has performed power generation for a certain time period. The fuel 111 inside the fuel storage portion 110 is consumed by the power generation, thus decreasing. Since the partition plate 130 is normally pressed toward the fuel storage portion 110 by the fuel pressurizing portion 120, there arises no void space in the fuel storage portion 110, and the fuel within the fuel storage portion 110 is constantly supplied to the fuel discharge port 160.

As shown above, since the partition plate 130 is normally pressed toward the fuel storage portion 110 after the start of power generation so that the fuel within the fuel storage portion 110 is constantly supplied to the fuel discharge port 160, the fuel tank 100 of this first embodiment is enabled to supply the fuel 111 stably to the fuel cell main unit, whichever direction the fuel tank 100 is arranged along.

Further, the emission 123 produced in the fuel cell main unit is supplied to the fuel pressurizing portion 120 so as to be utilized for the pressing of the partition plate 130, this fuel tank 100 is enabled to perform the disposal of the emission 123 at the same time.

Second Embodiment:

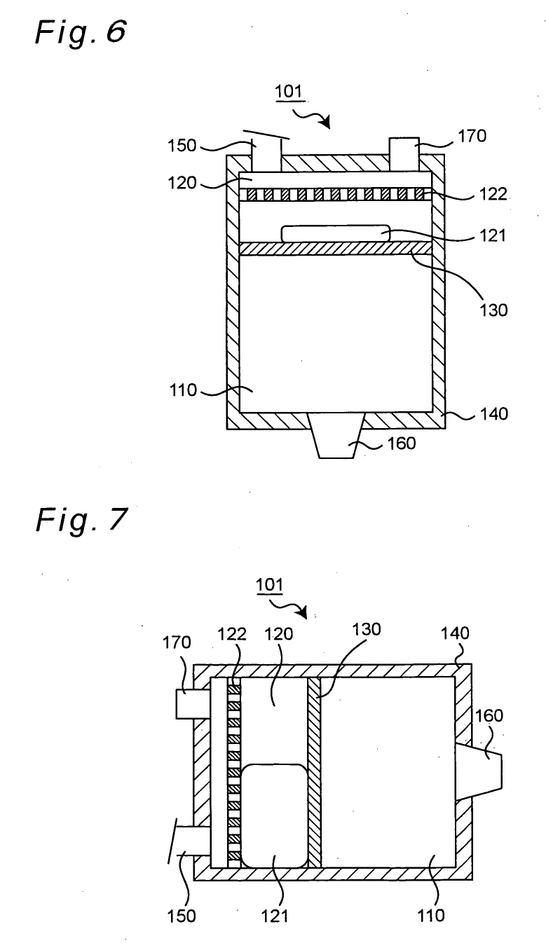

FIGS. 6 and 7 are schematic diagrams of a fuel tank 101 for the fuel-cell in a second embodiment. The fuel tank 101 is so constructed that in the fuel tank 100 of the first embodiment described above, a water absorptive member 121 and a partition wall 122 are further provided in the fuel pressurizing portion 120. The rest of the construction is similar to that of the fuel tank 100, and the construction of different portions is described below.

The water absorptive member 121 can be attached, for example, to the partition plate 130 as shown in the figure, but a position of the water absorptive member 121 is not particularly limited only if it is within the fuel pressurizing portion 120. This water absorptive member 121 is capable of retaining water in quantities tens to hundreds times larger than an initial dry volume, being a material which swells with water absorption. As the water absorptive member 121, in particular, high water absorptive polymers are preferable in terms of water absorptivity and cost, and more particularly, carboxymethylcellulose- or other cellulose-based high water absorptive polymers, PVA water-absorptive gel freezing/thawing elastomers or other polyvinyl-alcohol-based high water absorptive polymers, or polyacrylic sodium cross-linked substances or other acrylate-based high water absorptive polymers, or the like are preferable.

The partition wall 122, which serves to prevent the water absorptive member 121 from blocking the pressure bleeding valve 150 and the receiving port for emission 170 when the water absorptive member 121 has swollen so as to be increased in volume, is placed at a position which is within the fuel pressurizing portion 120 and which is slightly separate from the pressure bleeding valve 150 and the receiving port for emission 170 as shown in the figure.

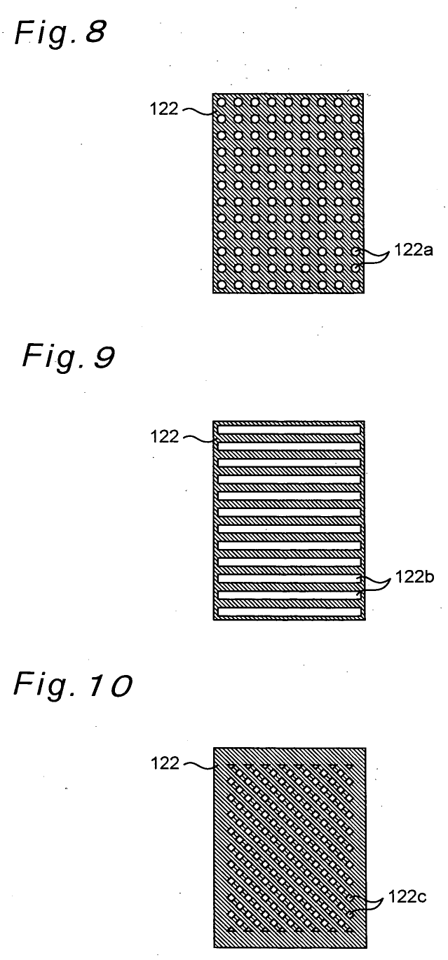

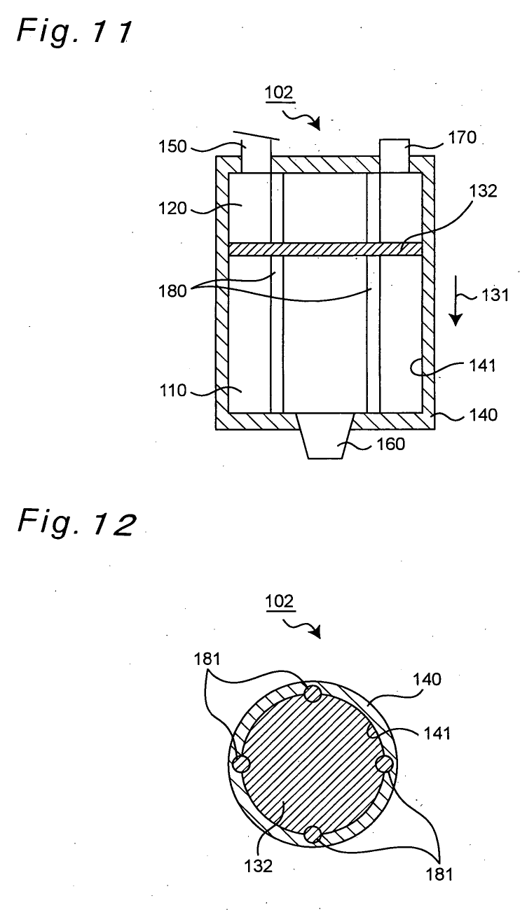

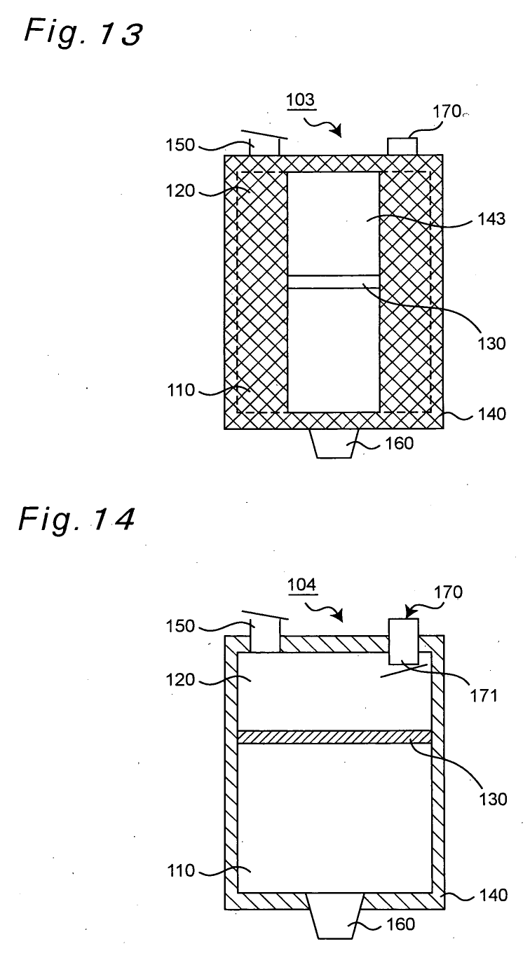

Materials usable for the partition wall 122 are exemplified by polymeric resins such as polyethylene terephthalate, polycarbonate and Teflon®, and metals such as aluminum and stainless steel. Also, the partition wall 122 needs to have openings that allow gaseous or liquid components supplied from the receiving port for emission 170 to pass therethrough. Therefore, a conceivable structure of the partition wall 122 is, for example, one in which round holes 122a as shown in FIG. 8, or slits 122b as shown in FIG. 9, or meshes 122c as shown in FIG. 10, corresponding to the openings are provided. It is noted that the place where the openings 122a to 122c are placed may be either entire or partial region of the partition wall 122. In addition, in FIGS. 8 to 10, the hatching does not show the cross section but represents non-opening portions.

With regard to the fuel tank 101 of the second embodiment constructed as described above, operation of the fuel tank 101 is described in the state that the fuel tank 101 and the fuel cell main unit are connected to each other. Since the basic operation that the partition plate 130 is pressed by the supply of the emission 123 so as to pressurize the fuel 111 is similar to the above-described operation in the fuel tank 100, here are described operations related to the water absorptive member 121 and the partition wall 122, which are characteristic structural components of the fuel tank 101.

Upon a start of power generation in the fuel cell main unit, the gas that has passed through the cathode of the fuel cell main unit and the liquid produced at the cathode are supplied to the receiving port for emission 170. In the fuel pressurizing portion 120, the supplied liquid is absorbed by the water absorptive member 121, and the internal pressure of the fuel pressurizing portion is increased by the supplied gas, producing an effect similar to the effect of the foregoing first embodiment. As the power generation continues, the supply amount of the liquid produced at the cathode increases, and as the water absorption amount of the water absorptive member 121 increases, the volume of the water absorptive member 121 increases. For example, in the case where the fuel tank 101 is arranged in a horizontal orientation as shown in FIG. 7, the water absorptive member 121, when having become a certain volume or more, comes into contact with the partition wall 122 so as to be swollen along the partition wall 122. Thus, with the partition wall 122 provided, the water absorptive member 121 can be prevented from blocking the pressure bleeding valve 150 and the receiving port for emission 170 even if the water absorptive member 121 is swollen.

Thus, the fuel tank 101 is also enabled to supply the fuel 111 to the fuel cell main unit, whichever orientation it is placed along, as in the case of the above-described fuel tank 100, and moreover the fuel tank 101 is further enabled to reclaim the liquid produced at the cathode of the fuel cell main unit without emitting the liquid to the outside of the fuel cell system.

Third Embodiment:

FIGS. 11 and 12 are schematic diagrams of a fuel tank 102 for the fuel-cell in a third embodiment. The fuel tank 102 is so constructed that the fuel tank 100 of the first embodiment is further provided with a partition-plate moving guide portion for guiding the movement of the partition plate 130 within the casing 140 toward the move direction 131. The rest of the construction is similar to that of the fuel tank 100, and the construction of different portions is described below. It is noted that the partition plate in the fuel tank 102 of the third embodiment is designated by reference numeral 132.

FIG. 11 includes guide rods 180 as an example having the function of the partition-plate moving guide portion. The guide rods 180 are provided in the casing 140 so as to be parallel to the move direction 131 of the partition plate 132, i.e., the axial direction of the casing 140 and to be penetrated through the partition plate 132 in continuation to the fuel pressurizing portion 120 and the fuel storage portion 110 within the casing 140. The guide rods 180 are not particularly limited in their thickness and number and, preferably, have lower occupancies in the fuel storage portion 110 and the fuel pressurizing portion 120 in terms of the volumetric efficiency of the fuel tank 102. A material of the guide rods 180, which is not particularly limited only if it is not dissolved or swollen in the fuel 111 or water, is exemplified by polymeric resins such as polyethylene and polypropylene and metals such as aluminum and stainless steel.

In addition, in the partition plate 132, a seal member such as an O-ring for preventing leakage of the fuel 111 and the emission 123 is provided at each of penetrated portions of the guide rods 180.

As another example having the function of the partition-plate moving guide portion, depressed/projected portions 181 having a depressed or projected configuration may also be formed along the move direction 131 on the inner wall 141 of the casing 140 as shown in FIG. 12. In this case, portions of the partition plate 132 confronting the depressed/projected portions 181 are formed into a projected or depressed configuration in correspondence to the configuration of the depressed/projected portions 181 so as to be engaged with the depressed/projected portions 181. The number of the depressed/projected portions 181 is not particularly limited, but preferably within a range of 2 to 8, because one in number causes a high likelihood that the partition plate 130 may be disengaged from the one depressed/projected portion 181 while nine or more in number causes machining load to increase. Further, the seal members are provided also at the portions of the partition plate 132 confronting the depressed/projected portions 181.

With regard to the fuel tank 102 of the third embodiment constructed as described above, below described is operation of the fuel tank 102 in a state that the fuel tank 102 and the fuel cell main unit are connected to each other. Since the basic operation is similar to the above-described operation in the fuel tank 100, here are described operations related to the partition-plate moving guide portions 180, 181, which are characteristic structural components of the fuel tank 102.

Upon a start of power generation in the fuel cell main unit, the partition plate 132 is pressed and moved toward the fuel storage portion 110 by the operation described in the first embodiment. Since the guide rods 180 are disposed along the move direction 131 so as to be penetrated through the partition plate 132, the partition plate 132 is moved along the guide rods 180. Thus, the move direction of the partition plate 132 is fixed only to a direction parallel to the guide rods 180. Therefore, even if a strong shock or the like has acted on the fuel tank 102, the partition plate 132 is prevented from tilting, thus enabled to keep the fuel storage portion 110 and the fuel pressurizing portion 120 partitioned. Thus, the storage contents of the fuel storage portion 110 and the fuel pressurizing portion 120 are prevented from being mixed together.

Further, even when the depressed/projected portions 181 shown in FIG. 12 are provided, the same working effects as with the guide rods 180 can be obtained.

Fourth Embodiment:

FIG. 13 is a schematic diagram of an appearance of a fuel tank 103 for the fuel-cell in a fourth embodiment. In the fuel tank 103, a see-through portion 143 is provided on the casing 140. The rest of the construction is similar to that of the fuel tank 100, and the construction of different portions is described below.

The see-through portion 143 may be either transparent or translucent, and the see-through portion 143 may be formed over part or entirety of the casing 140 along the axial direction of the casing 140. The see-through portion 143, when formed on the casing 140 along the axial direction of the casing 140, is preferably formed over the generally entire length of the casing 140 as shown in the figure. As material to be used for the see-through portion 143, for example, polymeric resin materials such as polyethylene, polypropylene, polycarbonate, and Teflon® are preferable. Also, in the case where the see-through portion 143 is provided, preferably, the partition plate 130 is partly or entirely colored. Its color, although not particularly limited, is preferably a color different from that of the casing 140 and, for example, the color of the partition plate 130 is preferably white or the like when the casing 140 is black. In the case where part of the partition plate 130 is colored, the colored part is of course placed in correspondence to the see-through portion 143 on the casing 140 so that the colored part can be visually recognized from the outside of the tank via the see-through portion 143.

In addition, the coloring is a concept which refers to not only cases of intentional coloring but also the material color of the partition plate 130.

With regard to the fuel tank 103 of the fourth embodiment constructed as described above, below described is operation of the fuel tank 103 in a state that the fuel tank 103 and the fuel cell main unit are connected to each other. Since the basic operation is similar to the above- described operation in the fuel tank 100, here is described operation related to the see-through portion 143, which is a characteristic structural component of the fuel tank 103.

Upon a start of power generation in the fuel cell main unit, the partition plate 130 is pressed and moved toward the fuel storage portion 110 as in the first embodiment. When the colored partition plate 130 has reached up to the see-through portion 143, the position of the partition plate 130 can be visually recognized from the outside of the fuel tank 103. The partition plate 130 is enhanced in visibility by being colored, and its effect is increased particularly by making the partition plate 130 different in color from the casing 140. Conversely, for example, when the partition plate 130 is transparent, its boundary with the fuel 111 is difficult to distinguish, resulting in a lower visibility.

The partition plate 130 is present at all times at the boundary portion between the fuel storage portion 110 and the fuel pressurizing portion 120. Therefore, according to the fuel tank 103 of the fourth embodiment, it becomes possible to check a remaining quantity of the fuel 111 within the fuel storage portion 110 by the position of the partition plate 130. Therefore, by the provision of the see-through portion 143 and the partition plate 130 colored different in color from the casing 140, a fuel indicator by the partition plate 130 can be provided.

Fifth Embodiment:

FIG. 14 is a schematic diagram of a fuel tank 104 for the fuel-cell in a fifth embodiment. The fuel tank 104 is so constructed that a check valve 171 is provided at the receiving port for emission 170 of the fuel tank 100 of the first embodiment. The rest of the construction is similar to that of the fuel tank 100, and the construction of different portions is described below.

The check valve 171 serves to prevent back flow of the liquid supplied to the fuel pressurizing portion 120 through the receiving port for emission 170. The check valve 171 is disposed, for example, at an outlet portion of the receiving port for emission 170 within the fuel pressurizing portion 120.

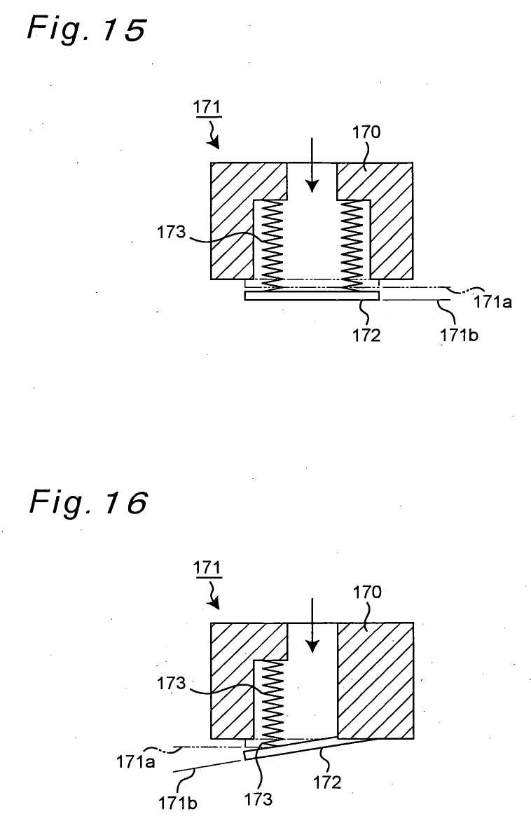

A schematic diagram of an example of the check valve 171 is shown in FIG. 15. The check valve 171 has a back-flow preventing member 172 and a spring 173, and the back-flow preventing member 172 may be given by using polymeric resins such as polyethylene and polypropylene or metals such as aluminum and stainless steel.

In the check valve 171 constructed as described above, without inflow of the emission 123 into the fuel pressurizing portion 120, the back-flow preventing member 172 is located at a closure position 171a by shrinkage force of the spring 173, thus preventing the emission 123 within the fuel pressurizing portion 120 from flowing back. On the other hand, with the inflow of the emission 123 into the fuel pressurizing portion 120, the back-flow preventing member 172 overcomes the shrinkage force of the spring 173 by the inflow pressure of the emission 123 so as to be located at an open position 171b, thus enabling the supply of the emission 123 into the fuel pressurizing portion 120.

Alternatively, a mode shown in FIG. 16 may be adopted as another example of the check valve 171. In comparison to the mode shown in FIG. 15, the check valve 171 is so constructed that one end portion of the back-flow preventing member 172 is supported by a hinge, thus the construction being simplified. In this construction, polymeric resins such as polyethylene and polypropylene are preferable as the material of the back-flow preventing member 172.

With regard to the fuel tank 104 of the fifth embodiment constructed as described above, below described is operation of the fuel tank 104 in a state that the fuel tank 104 and the fuel cell main unit are connected to each other. Since the basic operation is similar to the above- described operation in the fuel tank 100, here is described operation related to the check valve 171, which is a characteristic structural component of the fuel tank 104.

Upon a start of power generation in the fuel cell main unit, the gas that has passed through the cathode of the fuel cell main unit and the liquid produced at the cathode are supplied from the receiving port for emission 170 through the check valve 171 to the fuel pressurizing portion 120. By this supply, the internal pressure of the fuel pressurizing portion 120 is increased, causing the partition plate 130 to be pressed and moved. On the other hand, upon a halt of power generation, the supply of gas and liquid to the receiving port for emission 170 is halted, the back-flow preventing member 172 of the check valve 171 is located at the closure position 171a by the shrinkage force of the spring 173, thus sealing the fuel pressurizing portion 120. Thus, the gas and liquid stored in the fuel pressurizing portion 120 can be prevented from flowing back through the receiving port for emission 170.

In particular, in a case where a fuel tank is connected to the fuel cell main unit at the fuel discharge port 160 and the receiving port for emission 170 and where the fuel tank and the fuel cell main unit are so constructed as to be attachable and removable, since the interior of the fuel pressurizing portion 120 is in a pressurized state, removing the fuel tank from the fuel cell main unit, without the provision of the check valve 171 at the receiving port for emission 170, would cause the liquid, which is the emission 123 reserved in the fuel pressurizing portion 120, to leak outside through the receiving port for emission 170, making electronic equipment or clothes wetted, which would lead to failures of the electronic equipment or stains of clothes. With respect to such problems, providing the check valve 171 at the receiving port for emission 170 prevents the above leakage.

Next, a fuel cell system which is another embodiment of the present invention is described below. The fuel cell system includes any one of the above-described fuel tanks 100 to 104 for the fuel-cell, and moreover has a fuel cell main unit to be connected to the fuel tank.

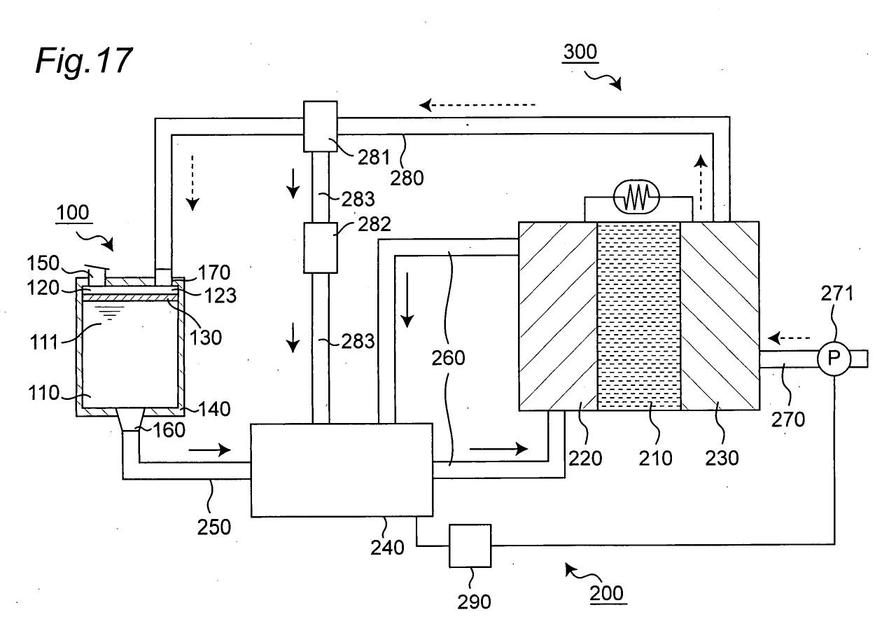

As shown in FIG. 17, the fuel cell system 300 of this embodiment includes the above-described fuel tank 100, a fuel cell main unit 200, a gas-liquid separation unit 281 and a water tank 282. Alternatively, any one of the above-described fuel tanks 101 to 104 may be provided instead of the fuel tank 100. Further, a pump for conveying liquid or the like at each path may be provided on each of below-described paths. It is noted that the pumps are omitted in the drawings.

The fuel cell main unit 200 includes an electrolyte membrane 210, an anode 220, a cathode 230, a buffer tank 240, a fuel supply path 250, a fuel circulation path 260, an air supply path 270 and an emission supply path 280.

The electrolyte membrane 210, which has a solid polymer electrolyte membrane, is placed so as to be sandwiched between the anode 220 and the cathode 230. The anode 220 has a multilayered structure of a catalyst for decomposing the fuel to pull out electrons, a fuel diffusion layer, and a separator as a collector. The cathode 230 has a multilayered structure of a catalyst for reacting proton and oxygen, a diffusion layer of air, and a separator as a collector. Platinum and ruthenium are used as the catalysts for the anode 220 and the cathode 230.

In addition, although FIG. 17 shows a case of one cell in which the electrolyte membrane 210, the anode 220 and the cathode 230 are provided each one in number in the fuel cell main unit 200, yet it is the actual case that a plurality of cells are connected, for example, in series to make up the fuel cell main unit 200.

The fuel supply path 250 is provided at the fuel discharge port 160 at the fuel storage portion 110 of the fuel tank 100, and the fuel supply path 250 is connected to the buffer tank 240. The buffer tank 240, which is connected to the anode 220 by the fuel circulation path 260, serves to mix the fuel 111 supplied from the fuel storage portion 110 and the water supplied from the water tank 282 together and further make the mixture circulated between the buffer tank 240 and the anode 220.

To the cathode 230 are connected the air supply path 270 as well as the emission supply path 280. The emission supply path 280 is connected to the receiving port for emission 170 at the fuel pressurizing portion 120 of the fuel tank 100 through the gas-liquid separation unit 281. The gas-liquid separation unit 281 is an unit for separating gas and liquid, which are the emission 123 emitted from the cathode 230, from each other, and the separated gas, or part of gas and liquid, is supplied to the fuel pressurizing portion 120 while the separated liquid is supplied to the buffer tank 240 through the water tank 282 by a water supply path 283. In this embodiment, the gas is air and the liquid is water.

In addition, on the air supply path 270 is provided, for example, a motor-driven air supply pump 271, which is provided in the fuel cell system 300 or provided outside the fuel cell system 300, so that air supply is performed at a rate of, for example, 2 liters per minute. Further, the buffer tank 240 and the air supply pump 271 are operationally controlled by a control unit 290 which is provided in the fuel cell system 300 or provided outside the fuel cell system 300.

In addition, as to the fuel tank 100, preferably, the fuel discharge port 160 of the fuel storage portion 110 is oriented along the gravitational direction. Also, the fuel discharge port 160 may also be oriented along the horizontal direction.

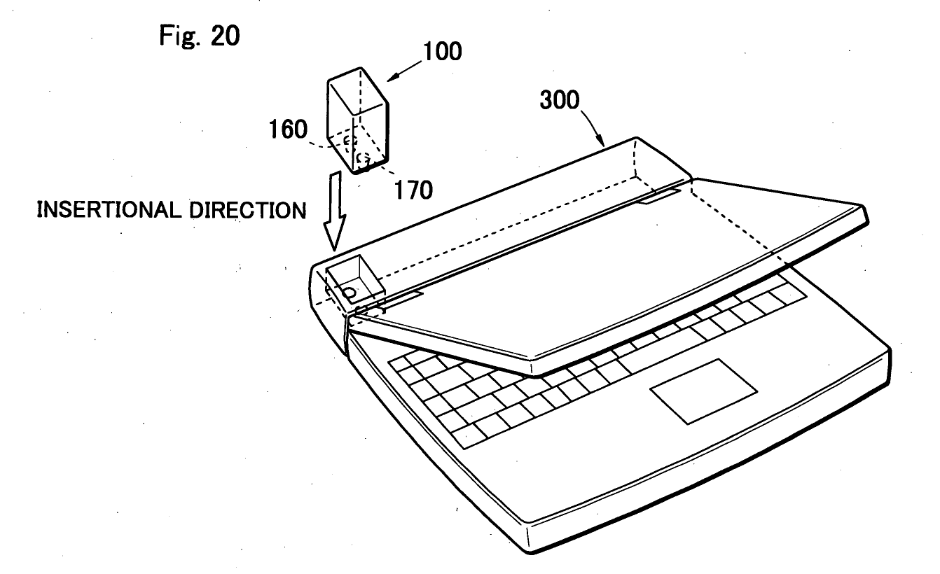

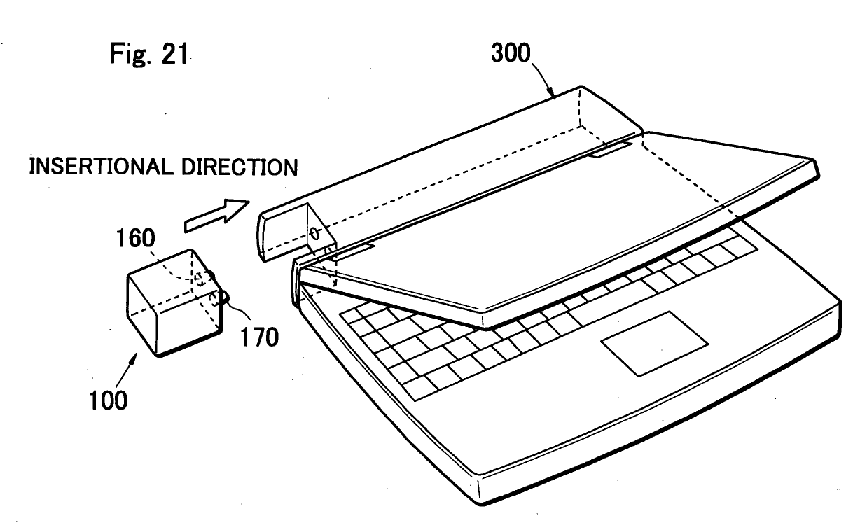

Furthermore, in order to facilitate the attachment and removal of the fuel tank 100, preferably, the fuel discharge port 160 and the receiving port for emission 170 are placed on one side face of the fuel tank 100 as shown in FIGS. 20 and 21. That is, by the placement of the fuel discharge port 160 and the receiving port for emission 170 on the one side face, the connection can be completed by simply inserting the fuel tank 100 into part of the fuel cell main unit 200. In this case, the pressure bleeding valve 150 is preferably arranged on one side face of the fuel tank 100 which is other than a lower side face parallel to a direction perpendicular to the gravitational direction and further which is different from the side face on which the fuel discharge port 160 and the receiving port for emission 170 are placed.

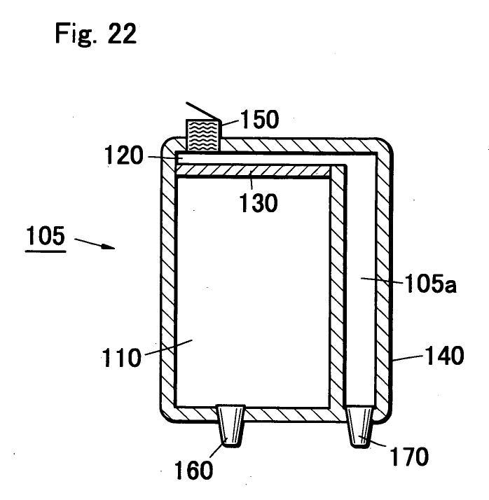

In addition, in a fuel tank 105 for the fuel-cell shown in FIG. 22 in which the fuel discharge port 160 and the receiving port for emission 170 are arranged on one identical side face as described above, an emission path 105a extending from the receiving port for emission 170 to the fuel pressurizing portion 120 is provided. The emission path 105a may be formed in such a constitution as could easily be conceived for those skilled in the art, for example, by partitioning the interior of the fuel tank 105 with a partition wall as shown in FIG. 22, or providing piping, or making the above-described guide rods 180 internally hollow.

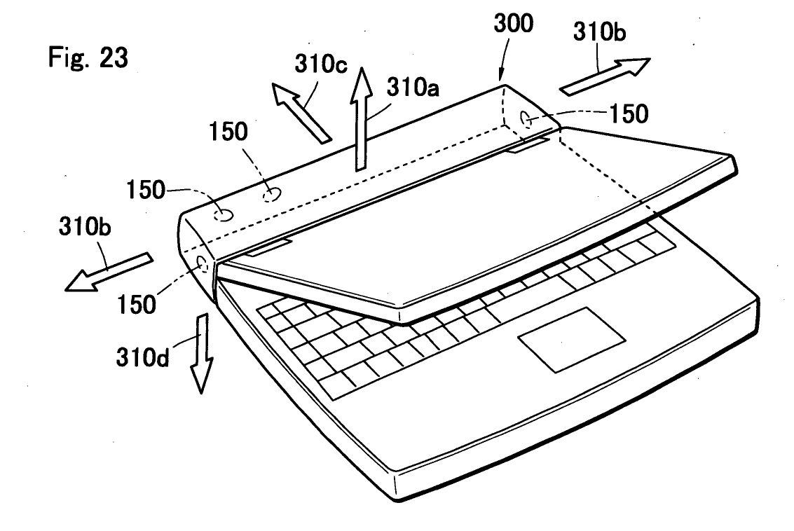

Further, when the fuel cell system 300 is used as the power supply of equipment, the pressure bleeding valve 150 needs to be placed in an orientation other than those toward the equipment side and the human body side. As to the reason of this, since the fuel cell main unit 200 comes to a temperature of about 60° C. during power generation, the gas discharged from the cathode 230 also becomes about 60° C., and the gas discharged from the pressure bleeding valve 150, although cooled more or less, also has several 10's of degrees Celsius. Moreover, the discharged gas contains water vapor. Therefore, the pressure bleeding valve 150, if located on the equipment side and the human body side, would adversely affect the equipment and the human body by heat, water contents or the like. For example, as shown in FIG. 23, in a case where the fuel cell system 300 is attached to a notebook personal computer as an example, since the user may in some cases operate the computer located, for example, on his or her knees, an orientation of the pressure bleeding valve 150 along a gravitational direction 310d cannot be adopted. Also, an orientation toward the computer side has to be avoided for the above-described reasons. Therefore, in this case, the pressure bleeding valve 150 is preferably oriented toward an upward orientation 310a, a side-face orientation 310b and a rear-face orientation 310c.

The fuel cell system 300 constructed as described above operates as follows.

The fuel 111, e.g. methanol, supplied to the fuel supply path 250 from the fuel discharge port 160 of the fuel tank 100, and water from the water tank 282 are supplied to the buffer tank 240 and mixed together. This mixture is supplied from the buffer tank 240 through the fuel circulation path 260 to the anode 220. The mixture solution of the fuel 111 and the water, after passing through the anode 220, is circulated to the buffer tank 240.

At the cathode 230, air or oxygen as the oxidizer is supplied to the cathode 230 through the air supply path 270 by the air supply pump 271. In the fuel cell main unit 200, the above-described reaction occurs at the anode 220 and the cathode 230 by Pt or Pt—Ru or other carbon-supported precious metal catalyst on the anode 220 and the cathode 230, by which power generation is performed.

The emission 123, which is composed of the air that has passed through the cathode 230 and the liquid containing water produced at the cathode 230, is supplied to the gas-liquid separation unit 281 through the emission supply path 280, and separated into gas and liquid. Out of the emission 123, the separated liquid is supplied to the water tank 282 through the water supply path 283. Also, part of the separated gas, or gas and liquid, is supplied to the receiving port for emission 170 of the fuel tank 100 through the emission supply path 280, and further supplied to the fuel pressurizing portion 120. By this supply operation, the pressure in the fuel pressurizing portion 120 is increased to press the partition plate 130 as described above.

Thus, the fuel cell system 300 has the emission supply path 280 for supplying the gas, which has passed through the cathode 230, and the liquid, which is produced at the cathode 230, from the cathode 230 of the fuel cell main unit 200 to the receiving port for emission 170 of the fuel tank 100. Therefore, the fuel pressurizing portion 120 of the fuel tank 100 is enabled to pressurize the fuel storage portion 110 of the fuel tank 100 by normally pressing the partition plate 130 toward the fuel storage portion 110 with the emission 123 derived from the cathode 230. Thus, since the fuel within the fuel storage portion 110 is supplied to the buffer tank 240 constantly via the fuel discharge port 160 and the fuel supply path 250, the fuel cell system 300, whichever orientation it is placed along, is enabled to stably supply the fuel 111 to the fuel cell main unit 200, so that a stable power generation can be performed.

Further, the emission 123 produced in the fuel cell main unit 200, i.e., the gas that has passed through the cathode 230 and the liquid that is produced at the cathode 230 are supplied to the fuel pressurizing portion 120 through the gas-liquid separation unit 281 so as to be utilized to press the partition plate 130. Thus, according to this fuel cell system 300, the disposal of the emission 123 can be performed at the same time.

In addition, since, theoretically, an amount of water three times larger than that of water consumed by the anode 220 is produced at the cathode 230 as described above, the amount of the emission 123 supplied to the fuel pressurizing portion 120 is larger than the amount of the fuel 111 consumed at the fuel tank 100, it seeming that, for example, water is often discharged from the pressure bleeding valve 150 provided at the fuel pressurizing portion 120. However, actually, a concentration of, for example, methanol to be supplied to the anode 220 is adjusted appropriately. Adjusting the concentration to, for example, 6.5 wt % makes it possible to make a sum of fuel consumed at the anode 220 and water nearly equal to the amount of the emission 123 supplied to the fuel pressurizing portion 120. Thus, it almost never occurs that water is discharged outside through the pressure bleeding valve 150.

Furthermore, although the fuel tank 100 is formed integrally with the fuel cell main unit 200 in the above-described fuel cell system 300, the fuel tank 100 may also be constituted so as to be attachable to and removable from the fuel cell main unit 200 as described above. Also, in a case where the fuel tank 100 does not have the reverse-move preventing portion 142 shown in FIG. 3, the partition plate 130 may be moved after the supply of fuel from the fuel tank 100 so that fuel is injected again into the fuel storage portion 110.

The present invention is applicable to a fuel tank to be connected to a fuel cell main unit in which power generation is performed while methanol or other organic fuel is being supplied directly to the anode, as well as fuel cell systems equipped with the fuel tank.

The entire disclosure of Japanese Patent Application No. 2003-173239 filed on Jun. 18, 2003 including specification, claims, drawings, and summary are incorporated herein by reference in its entirety.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1. A fuel tank for a fuel-cell which is connectable to a fuel cell main unit having an anode and a cathode, the fuel tank comprising:
a casing; and
a partition plate which is configured to move within the casing, is configured to partition interior of the casing into a fuel storage portion that stores a liquid fuel to be supplied to the anode and a fuel pressurizing portion that is capable of storing emission derived from the cathode, and further is configured to move by a pressure increase in the fuel pressurizing portion with the emission supplied to the fuel pressurizing portion so as to pressurize the liquid fuel in the fuel storage portion, without moving the partition plate when the emission is not supplied to the fuel pressurizing portion so as not to pressurize the liquid fuel.

2. The fuel tank as claimed in claim 1, wherein the emission is at least one of a gas and a liquid supplied from the cathode.

3. The fuel tank as claimed in claim 1, further comprising a pressure-increase preventing portion configured to prevent pressure increase beyond a set pressure value in the fuel pressurizing portion.

4. The fuel tank as claimed in claim 3, wherein the pressure-increase preventing portion is a pressure bleeding valve provided at part of the casing forming the fuel pressurizing portion.

5. The fuel tank as claimed in claim 1, further comprising a water absorptive member in the fuel pressurizing portion.

6. The fuel tank as claimed in claim 4, further comprising a water absorptive member in the fuel pressurizing portion.

7. The fuel tank as claimed in claim 5, wherein the water absorptive member is a water absorptive polymer.

8. The fuel tank as claimed in claim 7, wherein the water absorptive polymer is composed principally of at least one of cellulose, polyvinyl alcohol and acrylate.

9. The fuel tank as claimed in claim 1, further comprising a partition-plate moving guide portion configured to guide movement of the partition plate within the casing.

10. The fuel tank as claimed in claim 8, further comprising a partition-plate moving guide portion configured to guide movement of the partition plate within the casing.

11. The fuel tank as claimed in claim 9, wherein the partition-plate moving guide portion is depressed-and-projected portion formed on a casing inner wall.

12. The fuel tank as claimed in claim 9, wherein the partition-plate moving guide portion is a guide rod which is formed within the casing along an axial direction of the casing so as to penetrate the partition plate.

13. The fuel tank as claimed in claim 1, wherein at least part of the casing is made of a transparent or translucent material, and the partition plate at least partly has a colored part which allows remaining quantity of the liquid fuel within the fuel tank to be visually recognized.

14. The fuel tank as claimed in claim 12, wherein at least part of the casing is made of a transparent or translucent material, and the partition plate at least partly has a colored part which allows remaining quantity of the liquid fuel within the fuel tank to be visually recognized.

15. The fuel tank as claimed claim 1, further comprising an attachable-and-removable mechanism which allows the fuel-cell main unit and the fuel tank to be removably connected to each other.

16. The fuel tank as claimed claim 13, further comprising an attachable-and-removable mechanism which allows the fuel cell main unit and the fuel tank to be removably connected to each other.

17. The fuel tank as claimed in claim 15, wherein the attachable-and-removable mechanism has a check valve configured to prevent back flow of the emission from the fuel pressurizing portion to the cathode.

18. A fuel cell system comprising:
a fuel cell main unit which has an anode and a cathode with an electrolyte membrane sandwiched therebetween and which supplies a liquid fuel to the anode and supplies an oxidizer made of gas to the cathode so as to perform power generation; and
a fuel tank having a partition plate which is configured to move within a casing of the fuel tank, is configured to partition interior of the casing into a fuel storage portion that stores a liquid fuel to be supplied to the anode and a fuel pressurizing portion that is capable of storing emission derived from the cathode, and further is configured to move by a pressure increase in the fuel pressurizing portion with the emission supplied to the fuel pressurizing portion so as to pressurize the liquid fuel in the fuel storage portion, without moving the partition plate when the emission is not supplied to the fuel pressurizing portion so as not to pressurize the liquid fuel.

19. The fuel cell system as claimed in claim 18, wherein the fuel is a solution containing methanol and the gas is air.
